(19) United States
(12) Patent Application Publication
(10) Pub. No.: US 2005/0002485 A1
(43) Pub. Date: Jan. 6, 2005

(54) Method and apparatus of producing organic compound

(76) Inventors: Takeko Matsumura, Souraku-gun (JP); Kaori Saito, Moriguchi-city (JP); Yuji Hamada, Ikoma-gun (JP)

Correspondence Address: KUBOVCIK & KUBOVCIK, SUITE 710, 900 17TH STREET NW, WASHINGTON, DC, 20006, US

(21) Appl. No.: 10/847,666

(22) Filed: May 18, 2004

(30) Foreign Application Priority Data
May 19, 2003 (JP) 2003-140357

(51) Int. Cl. G21K 1/12

(52) U.S. Cl. 378/15

(57) ABSTRACT

A method of producing an organic compound, which includes the steps of irradiating a reaction solution with an electromagnetic wave having a wavelength range of 900 MHz to 30 GHz to heat the solution, thereby producing the organic compound, and removing a low-boiling point component produced through the reaction from a reaction system to facilitate the reaction.

### BACKGROUND OF THE INVENTION

1. Field of the Invention

The present invention relates to a method and an apparatus of producing an organic compound by irradiating a reaction solution with an electromagnetic wave to heat the solution.

2. Description of the Related Art

An organic electroluminescent (EL) device is expected as a new self-emitting device. Recently, an electroluminescent phosphor material receives attention as a high-efficiency light-emitting material in the organic EL device. Particularly in recent years, it has been reported that high-efficiency luminous characteristics is achieved by using iridium (III) tris(2-phenylpyridinato-N,O), which is an ortho-metallized complex of iridium, as a light-emitting material, and this report has triggered the active developments of ortho-metallized complexes in which iridium or platinum is a dominant metal.

As a method of synthesizing a trisortho-metallized complex which is formed by coordinating three same ligands with iridium, there is known a method in which an acetylacetone complex of iridium (Ir(acac)₃) and a ligand are heat-refluxed in a high-boiling point solvent. However, in this method, there has a problem in that reaction requires a long time.

In “Rapid Synthesis of the Electroluminescent Materials Using Microwave Irradiation”, Hideo Konno and Yoshiyuki Sasaki, International Symposium on Microwave Science and Its Application to Related Fields (Industrial Technology International Conference, Nov. 21-23, 2002), extended abstracts, pp. 176-177 p-2, there has been proposed a method of synthesizing a trisortho-metallized complex by heating technique with a microwave using chlorides such as IrCl₃.3H₂O or (NH₄)₃ IrCl₆.nH₂O in place of Ir(acac)₃ as a starting material.

However, in the above method, there has a problem in that it is required to use ligands too excessively in an amount of 50 to 100 equivalent with respect to iridium material in order to selectively obtain a trisortho-metallized complex and this method is economically disadvantageous in the case of using expensive ligands as a raw material.

In the above method of using Ir(acac)₃ as a starting material, there has a problem in that a reaction temperature can not be raised since acetylacetone, which is a low-boiling point component, is produced and refluxed; therefore, an ortho-metallized complex can not be efficiently synthesized.

### SUMMARY OF THE INVENTION

It is an object of the present invention to provide a method and an apparatus by which an organic compound can be efficiently produced in the synthesis of an organic compound in which a low-boiling point component is produced through a reaction.

The present invention concerns a method of producing an organic compound by irradiating a reaction solution with an electromagnetic wave having a wavelength range of 900 MHz to 30 GHz to heat the solution, and removing a low-boiling point component produced through the reaction from a reaction system to facilitate the reaction.

In accordance with the present invention, since the reaction is made proceed by removing a low-boiling point component produced through a reaction from a reaction system, it is possible to raise a temperature of a reaction solution without being affected by the presence of the low-boiling point component and to allow the reaction in the reaction solution to efficiently proceed. Therefore, an organic compound can be efficiently produced in a short time.

Further, in the present invention, since a reaction solution is heated by being irradiated with an electromagnetic wave, the reaction solution can be efficiently heated, and an organic compound can be efficiently produced also from this point.

In the present invention, though the electromagnetic wave irradiated to a reaction solution has the wavelength range of 900 MHz to 30 GHz, its wavelength may be appropriately selected depending on starting materials, organic compounds to be synthesized, solvents and the like. Generally, a microwave is preferably used and, particularly, a microwave of 2.45 GHz is preferably used.

In the present invention, the organic compound produced by a reaction is preferably an organic compound containing metal. Examples of such a compound may include luminescent materials, which are metal coordination compounds having a carbon atom-metal bond and a hetero atom-metal bond, and used for organic electroluminescent (EL) devices, carrier transport material, or possible carrier injection materials. In particular, there are given organic metal complexes composed of transition metal and one or more kinds of ortho-metallized ligands. In such complexes, a low-boiling point component is a ligand such as acetylacetone. Examples of the transition metal may include at least one kind selected from Ir (iridium), Pt (platinum), Pd (palladium), Rh (rhodium), Re (rhenium), Ru (ruthenium), Os (osmium), Au (gold) and Ag (silver).

In the present invention, the reaction solution generally contains a solvent. As such a solvent, a solvent having a hydroxyl group is preferable from the viewpoint of absorbing an electromagnetic wave efficiently and heating. Examples of the solvent having the hydroxyl group may include at least one kind selected from glycerol, ethylene glycol, triethylene glycol and water (H₂O).

In addition, as a solvent other than the solvent having the hydroxyl group, there may be used amidic and imidic solvents such as N,N-dimethylformamide (DMF), dimethyl sulfoxide (DMSO), and N-methyl pyrrolidone (NMP), as well as high-boiling point solvents such as toluene and polyethylene carbonate.

As the solvent in the present invention, a solvent, exhibiting a high dielectric constant and having a high boiling point, is preferred. The boiling point of the solvent is preferably higher than that of low-boiling point component.

In the present invention, the reaction solution may not contain a solvent. When it contains a solvent, generally, the solvent is heated and therefore a temperature of the reaction solution is elevated by utilizing a dielectric loss by a solvent. However, when the reaction solution does not contain a solvent, it is preferred to mix a dielectric material such as ceramic in the reaction solution and to heat the reaction solution by a dielectric loss of this dielectric material. In addition, a reaction may be performed by impregnating inorganic oxides such as alumina or silica gel with raw materials to be used in a reaction.

In the present invention, a temperature of the reaction solution may be controlled by varying an output of an electromagnetic wave during a reaction. For example, at the beginning of a reaction, the reaction solution temperature may be controlled by raising it to a first setting temperature which is higher than a boiling point of a low-boiling point component and lower than a boiling point of a solvent to distill a low-boiling point component and remove it from a reaction system, and then by varying an output of an electromagnetic wave so as to raise the reaction solution temperature to a second setting temperature being higher than the first setting temperature. By controlling the reaction solution temperature like this, the low-boiling point component can be distilled and driven out of a reaction system when the reaction solution temperature is raised to the first setting temperature, and by raising the reaction solution temperature to a higher temperature after removing the low-boiling point component, the reaction can be accelerated. It is also possible to condense the reaction solution by removing a solvent during or after a reaction as required.

In the present invention, it is preferred to inject a nitrogen gas into the reaction solution and to bubble the solution with the nitrogen gas during a reaction. By bubbling the reaction solution with the nitrogen gas like this, the formation of a by-product due to oxidation, which is produced by a reaction with oxygen in the reaction solution, can be suppressed.

In the present invention, it is preferred to conduct bubbling treatment of the nitrogen gas on the solvent before a reaction by injecting nitrogen gas while heating only the solvent. Thereby, the oxygen contained in the solvent can be removed and the formation of a by-product due to oxidation can be suppressed further.

A production apparatus of the present invention is an apparatus for producing an organic compound by irradiating a reaction solution with an electromagnetic wave to heat the solution, and comprises a reaction container for containing a reaction solution, an electromagnetic wave generating unit for irradiating the reaction solution with an electromagnetic wave, a cooling unit for cooling and liquefying the low-boiling point component produced through a reaction and evaporated in the reaction solution, a reservoir section for storing the liquefied low-boiling point component in order to prevent it from returning to a reaction container and a temperature sensing means for sensing a reaction solution temperature.

In the production apparatus of the present invention, the apparatus is adapted to cool and liquefy the low-boiling point component produced through a reaction and evaporated in the reaction solution with a cooling unit, and to store the liquefied low-boiling point component in a reservoir section to prevent it from returning to a reaction container. Therefore, since the low-boiling point component can be removed a reaction system during a reaction and the temperature of a reaction solution can be raised without being affected by the presence of the low-boiling point component, it is possible to efficiently heat the reaction solution and to efficiently produce the organic compound.

In the production apparatus of the present invention, a container, for example, made of glass or fluorocarbon resin may be used as the reaction container. When the fluorocarbon resin container is used, it is possible to reduce an escape of an irradiated electromagnetic wave out of the container and efficiently absorb the electromagnetic wave in the reaction solution.

As the cooling unit for cooling the low-boiling point component, there is given a cooling tube around which cooling water is circulated.

The reservoir section for storing the liquefied low-boiling point component is not particularly limited and any one may be used as long as it can store the low-boiling point component cooled and liquefied in the cooling unit so as to prevent the component from returning to a reaction container.

As the temperature sensing means, there is given a temperature sensor such as an infrared sensing detector and a fiber optic temperature sensor.

When an organic compound is an organometallic complex, metal may be readily oxidized by residual oxygen in a solvent. Therefore, it is preferred to heat only a solvent and bubble the solvent with a nitrogen gas before a reaction. Furthermore, it is preferred to bubble the reaction solution with a nitrogen gas also in a reaction. Accordingly, in the apparatus of the present invention, it is preferred to further install a nitrogen gas bubbling unit. The formation of a by-product due to oxidation can be suppressed by bubbling the reaction solution with the nitrogen gas.

In the apparatus of the present invention, it is preferred to install an antenna stirrer such as a magnetic stirrer, which is operated externally, in order to stir the reaction solution in the reaction container.

It is also preferred to provide a circumference of an opening of the apparatus with a metallic attenuator or mesh guard in order to prevent leakage of an electromagnetic wave from the apparatus.

In accordance with the present invention, the organic compound can be efficiently produced. For example, when iridium (III) tris(2-phenylpyridinato-N,O) [Ir(ppy)₃] is synthesized by reacting an iridium acetylacetonato complex [Ir(acac)₃] with 2-phenylpyridine, Ir(ppy)₃ can be selectively obtained in a reaction time about one-tenth part of that of a conventional heating method only by using ligands in an amount of 1 to 5 equivalent with respect to Ir(acac)₃.

In the present invention, when a microwave is used as an electromagnetic wave, an output of the microwave may be used, for example, in a range of 30 W to 3 KW. The output of the microwave may be varied with time. For example, the temperature of the reaction solution may be rapidly elevated by setting the output of the microwave at 250 W or more at the initiation of reaction, and then the output of the microwave may be lowered to 30 to 50 W to perform the reaction. Thus, the output of the electromagnetic wave in a reaction may be varied manually or automatically to perform the reaction.

### BRIEF DESCRIPTION OF THE DRAWINGS

FIG. 1 is a schematic view showing an embodiment of a production apparatus according to the present invention.

### DESCRIPTION OF THE PREFERRED EMBODIMENT

Hereinafter, the present invention will be described in detail by way of an embodiment, but the present invention is not limited to the embodiment and its modification may be appropriately made as long as the gist of the present invention is not changed.

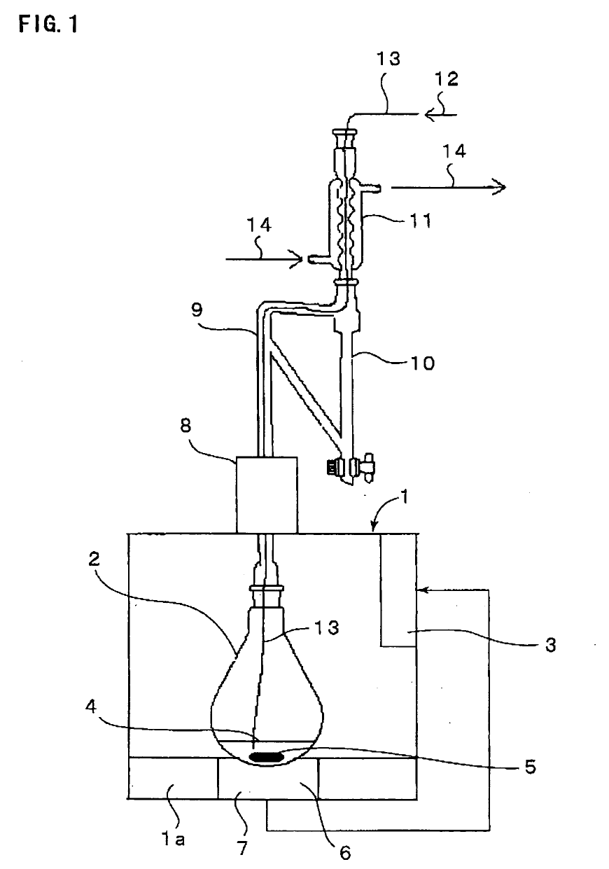

FIG. 1 is a schematic view showing an embodiment of a production apparatus according to the present invention. In a reaction chamber 1, a reaction container 2 for containing a reaction solution is installed on a base 1a. The inside of the base 1a is provided with a temperature sensor 6 for detecting the temperature of the reaction solution in the reaction container 2 with infrared rays. In addition, in the reaction container 2 is located a stirring element 5 for stirring the reaction solution, and in the base 1a is mounted a magnetic stirrer 7 for rotating the stirring element 5.

The inside of the reaction chamber 1 is provided with an electromagnetic wave generating unit 3 for irradiating the reaction solution in the reaction container 2 with an electromagnetic wave. This electromagnetic wave generating unit 3 can irradiate a microwave having a wavelength of 2.45 GHz.

The reaction container 2 is a glass recovery flask and a glass tube 9 is attached to the top of the reaction container 2. The glass tube 9 is branched into two sections, and a cooling tube 11 as a cooling unit is connected to an upper glass tube 9. The inside of the cooling tube 11 is adapted to pass cooling water 14. A reservoir section 10 is installed beneath the cooling tube 11. The low-boiling point component cooled and liquefied in the cooling tube 11 fall downward into the reservoir section 10 and stored in the reservoir section 10.

A bubbling pipe 13 is passed from the upper side of the cooling tube 11 through the glass tube 9 into the reaction container 2. By introducing a nitrogen gas 12 in this bubbling pipe 13, it is possible to inject the nitrogen gas into the reaction solution in the reaction container 2 to bubble the reaction solution.

The glass tube 9 is passed into the upper section of the reaction container 2 of the reaction chamber 1 and an upper wall of the reaction chamber 1 is provided with an opening. A circumference of this opening is provided with a metallic attenuator 8 in order to prevent leakage of an electromagnetic wave from the reaction chamber 1.

The reaction solution 4 in the reaction container 2 is heated by the electromagnetic wave generated from the electromagnetic wave generating unit 3. The reaction solution 4 is stirred by the stirring element 5 rotated by the magnetic stirrer 7. The reaction solution 4 is also bubbled with the nitrogen gas 12 supplied from the bubbling pipe 13. The temperature of the reaction solution 4 is detected by the temperature sensor 6, and signals of the sensor are sent to the electromagnetic wave generating unit 3 and an output of the electromagnetic wave is controlled in such a way that the temperature of the reaction solution does not exceed a setting temperature.

Low-boiling point component such as acetylacetone is produced by a reaction in the reaction solution 4, and the low-boiling point component reaches the cooling tube 11 through the glass tube 9 and are cooled and liquefied with the cooling water 14 in the cooling tube 11. The liquefied low-boiling point component falls downward and are stored in the reservoir section 10. Therefore, the low-boiling point component from the reaction solution 4 does not return to the reaction solution 4 as distinct from a conventional reflux method. Accordingly, the low-boiling point component is removed from the reaction solution 4 as the reaction proceeds, and the temperature of the reaction solution 4 can be increased to elevated temperature without being affected by the presence of the low-boiling point component.

### EXAMPLE 1

Using an apparatus shown in FIG. 1, iridium (III) tris(2-phenylpyridinato-N,O) [Ir(ppy)₃] was prepared. A reaction formula of Ir(ppy)₃ synthesis is shown below.

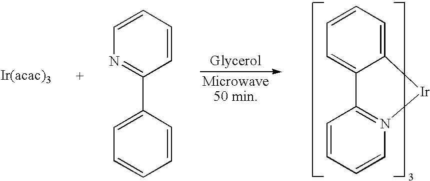

Using a 100 ml glass recovery flask as a reaction container, in this flask were put 1.0 g (2.04 mmol) of an iridium acetylacetonato complex [Ir(acac)₃], 1.1 g (7.10 mmol) of 2-phenylpyridine and 5 ml of glycerol to form a reaction solution and the reaction solution was irradiated with a microwave having a wavelength of 2.45 GHz while being bubbled with a nitrogen gas. An output of a microwave and a reaction temperature were set at 300 W and 200° C., respectively. This setting temperature of 200° C. is higher than an acetylacetone boiling point of 140.4° C. and lower than a glycerol boiling point (decomposition temperature) of 290° C. Though the temperature of the reaction solution reached as low as 170° C. initially, it was elevated from about the time the acetylacetone of the low-boiling point component started distilling about 10 minutes later.

When the reaction solution temperature reached about 200° C., the setting temperature was increased to 250° C. After this, the output of the microwave was set at 30 W. Finally, the reaction solution temperature reached 240° C.

The reaction was completed at 50 minutes after the reaction was initiated and the reaction solution was left standing until it cooled. A small amount of ethanol was added to the reaction solution and the mixture was filtered to obtain a yellow solid matter. The resulting solid matter was purified and dried with a column chromatography (filler: silica gel, eluent: methylene chloride). The yield of the solid matter was 492 mg and 37%. In measurements of photoluminescence on this purified compound in dichloroethane, green luminescence having a maximum wavelength of 516 nm was exhibited, and this result agreed with the value of Ir(ppy)₃ in a literature.

### COMPARATIVE EXAMPLE 1

When in the apparatus shown in FIG. 1, the cooling tube 11 was attached directly above the reaction container 2 to construct the apparatus not including the reservoir section 10, and using this apparatus and the reaction solution similar to that in Example 1, the reaction solution was heated by being irradiated with a microwave at an output of 300 W as is the case with Example 1, the reaction solution temperature reached as low as 170° C. After the reaction for 50 minutes, the reaction solution was filtered following the same procedure as in Example 1 to obtain a yellow solid matter. The yield of the solid matter was 187 mg and 14%.

Thus, in accordance with the present invention, the yield could be enhanced from 14% to 37% and it was found that the yield could be redoubled.

### COMPARATIVE EXAMPLE 2

When Ir(ppy)₃ was produced by being heated with a conventional technique (a mantle heater) instead of heating through the irradiation of an electromagnetic wave using the apparatus in Comparative Example 1, the yield of Ir(ppy)₃ after the reaction of 10 hours was about 40%.

### EXAMPLE 2

Following the same procedure as in Example 1 and using an apparatus shown in FIG. 1, iridium (III) tris(2-phenylquinolinato-N,O) [Ir(phq)₃] was synthesized. A reaction formula is shown below.

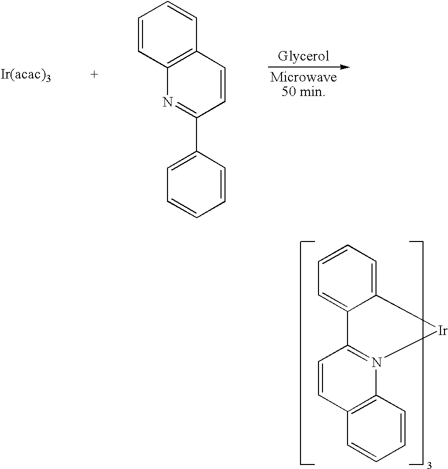

In a 100 ml recovery flask were put 1.0 g (2.04 mmol) of Ir(acac)₃, 1.45 g (7.10 mmol) of 2-phenylquinoline and 5 ml of glycerol and a microwave similar to that of Example 1 was irradiated to the mixture at an output of 150 W and a reaction was initiated with a reaction temperature set at 200° C. Though the temperature of the reaction solution reached as low as 170° C. initially, it was elevated from about the time the acetylacetone started distilling. When the reaction solution temperature reached 200° C. or more, an objective substance was produced. The reaction was completed at 15 minutes after the reaction was initiated and the reaction solution was left standing until it cooled. 20 ml of methylene chloride was added to the reaction solution, and only the layer of methylene chloride was extracted and purified with a column chromatography (filler: silica gel, eluent: methylene chloride) to obtain 32 mg of a red solid matter. In measurements of photoluminescence on this purified compound in dichloroethane, pink luminescence having a maximum wavelength of 589 nm was exhibited. Therefore, it was verified that Ir(phq)₃ was synthesized.

### COMPARATIVE EXAMPLE 3

Following the same procedure as in Comparative Example 2 and using a technique of heating with a conventional mantle heater, Ir(phq)₃ was synthesized. As a result of reacting the mixture for 10 hours, about 10 mg of desired Ir(phq)₃ was obtained. As is apparent from the above description, according to the present invention, Ir(phq)₃ can be efficiently synthesized in a short time.

In accordance with the present invention, the organic compound can be efficiently produced in the synthesis of the organic compound in which a low-boiling point component is produced through a reaction.

1. A method of producing an organic compound, comprising the steps of:
irradiating a reaction solution with an electromagnetic wave having a wavelength range of 900 MHz to 30 GHz to heat the solution, thereby producing the organic compound; and
removing a low-boiling point component produced through the reaction from a reaction system to facilitate the reaction.

2. The method according to claim 1, wherein
the organic compound produced through the reaction contains metal.

3. The method according to claim 2, wherein
the organic compound containing metal is a complex composed of transition metal and at least one kind of ortho-metallized ligand.

4. The method according to claim 3, wherein
the transition metal is at least one kind selected from Ir, Pt, Pd, Rh, Re, Ru, Os, Au and Ag.

5. The method according to claim 1, wherein
a solvent of the reaction solution has a hydroxyl group.

6. The method according to claim 5, wherein
the solvent having a hydroxyl group is at least one kind selected from glycerol, ethylene glycol, triethylene glycol and water.

7. The method according to claim 1, further comprising the steps of:
raising a reaction solution temperature to a first setting temperature which is higher than a boiling point of the low-boiling point component and lower than a boiling point of a solvent to distill and remove the low-boiling point component from the reaction system; and
controlling the reaction solution temperature by varying an output of an electromagnetic wave so as to raise the reaction solution temperature to a second setting temperature being higher than the first setting temperature.

8. The method according to claim 1, further comprising the step of:
injecting a nitrogen gas into the reaction solution and bubbling the solution with the nitrogen gas during the reaction.

9. An apparatus of producing an organic compound by irradiating a reaction solution with an electromagnetic wave to heat, the apparatus comprising:
a reaction container for containing the reaction solution;
an electromagnetic wave generating unit for irradiating the reaction solution with the electromagnetic wave;
a cooling unit for cooling and liquefying a low-boiling point component produced and evaporated in the reaction solution through a reaction;
a reservoir section for storing the liquefied low-boiling point component in order to prevent from returning to the reaction container; and
temperature-detecting means for detecting a reaction solution temperature.

10. The apparatus according to claim 9, wherein
the reaction container is made of glass or fluorocarbon resin.
